(19) United States
(12) Patent Application Publication
(10) Pub. No.: US 2026/0095045 A1
(43) Pub. Date: Apr. 2, 2026

(54) LONG-DISTANCE UNDERWATER POWER SUPPLY SYSTEM

(71) Applicant: HMN TECHNOLOGIES CO., LIMITED, Sino-Singapore Tianjin Eco-City (CN)

(72) Inventors: Yu DONG, Sino-Singapore Tianjin Eco-City, (CN); Weidong WU, Sino-Singapore Tianjin Eco-City (CN); Mao ZHAO, Sino-Singapore Tianjin Eco-City (CN); Jiehui ZHAO, Sino-Singapore Tianjin Eco-City (CN); Fang ZHANG, Sino-Singapore Tianjin Eco-City (CN); Li ZHANG, Sino-Singapore Tianjin Eco-City (CN)

(73) Assignee: HMN TECHNOLOGIES CO., LIMITED, Sino-Singapore Tianjin Eco-City (CN)

(21) Appl. No.: 19/069,738

(22) Filed: Mar. 4, 2025

(30) Foreign Application Priority Data
Sep. 29, 2024 (CN) 202411365497.7

(51) Int. Cl. H02J 1/04; H02J 1/10; H02J 50/10; H02M 3/335

(52) U.S. Cl. CPC H02J 1/04; H02J 1/10; H02J 50/10; H02M 3/33571; H02M 3/33573; H02J 2105/10; H02J 2105/50

(57) ABSTRACT

The present application relates to the field of underwater power supply technologies, and provides a long-distance underwater power supply system that is applied to a submarine observation system including a plurality of load nodes. The power supply system includes at least one terminal power supply and a plurality of branching nodes. The terminal power supply is sequentially electrically connected to the plurality of branching nodes through a trunk cable, and may output a constant current to the trunk cable. The plurality of branching nodes are respectively connected to at least one corresponding load node, and each of the branching nodes and the corresponding load node are connected to an ocean ground, respectively. The branching node may convert the constant current transmitted from the trunk cable into a constant-voltage current, and output the constant-voltage current to the load node.

### CROSS-REFERENCE TO RELATED APPLICATIONS

The present application claims priority to Chinese Patent Application No. 2024113654977 filed on Sep. 29, 2024, the entire disclosure of which is expressly incorporated by reference in its entirety herein.

### FIELD OF THE INVENTION

The present application relates to the field of underwater power supply technologies, and in particular, to a long-distance underwater power supply system.

### BACKGROUND OF THE INVENTION

A submarine observation network is an Earth scientific observation platform, where a land terminal station is disposed near a coast and various scientific observation instruments are disposed on a seabed, and terminal station devices are connected to the scientific instruments through submarine cables while continuous power supply and data transmission are achieved. Through this platform, various observation and detection instruments may operate constantly for a long time under a terminal-station power supply, and detection data is continuously transmitted to a land terminal-station communication device through optical fibers.

Power supply schemes for the submarine observation network at present are mainly divided into two types: a constant-voltage mode and a constant-current mode, where by the constant-voltage mode of power supply, typically a high-voltage direct current is generated from a power supply device at the terminal station, and a submarine device needs to convert the high-voltage direct current into an operating voltage required by the instrument through a high-voltage power supply; and by the constant-current mode of power supply, a direct current is generated from the power supply device at the terminal station, and the submarine device needs to convert the current into a required voltage.

However, in the constant-voltage mode of power supply, the design of the high-voltage power supply is complex, and faults generated in the power supply may affect all devices served by the power supply. Moreover, a high voltage may inevitably bring in noise and serious interference to lower-level devices, so that additional filtering measures need to be designed for the lower-level devices, which affects reliability of a power supply system. The constant-current mode of power supply is limited by loss of the submarine cables, where a total voltage for the device to draw power does not exceed a maximum output voltage of the power supply device at the terminal station, and thus this mode is only suitable for supplying power to small and medium power devices on a trunk submarine cable, and is not suitable for long-distance and multi-node submarine observation networks. Therefore, it has become a problem that urgently needs to be resolved how to stably and reliably supply power to the long-distance and multi-node submarine observation network.

### SUMMARY OF THE INVENTION

Embodiments of the present application provide a long-distance underwater power supply system to resolve a problem of low stability and reliability of a power supply system when supplying power to a long-distance and multi-node underwater system.

An embodiment of the present application provides a long-distance underwater power supply system that is applied to a submarine observation system including a plurality of load nodes. The power supply system includes at least one terminal power supply and a plurality of branching nodes. The terminal power supply is sequentially electrically connected to the plurality of branching nodes through a trunk cable, and is configured to output a constant current to the trunk cable. The plurality of branching nodes are respectively connected to the load nodes corresponding to the branching nodes, wherein each of the branching nodes corresponds to at least one load node. The branching node is electrically connected to the load node through a branch cable, and each of the branching nodes and each of the load nodes are respectively connected to an ocean ground. The branching node and the load node corresponding to the branching node return currents through the ocean ground. The branching node is configured to convert the constant current transmitted from the trunk cable into a constant-voltage current, and output the constant-voltage current to the load node.

In this way, the constant current output from the terminal power supply may be converted through the branching node to better supply power to the load node, and meanwhile, current return may be performed through grounding, so as to reduce cables disposed between the branching node and the load node, thereby reducing costs of long-distance power supply while reducing damages to stability of power supply that are caused by cable damages.

In a feasible implementation, the terminal power supply includes a plurality of power modules that are connected in series, and a positive terminal of one of the power modules is electrically connected to the trunk cable. In this way, the terminal power supply may output the constant current through the plurality of power modules, which increases power of the output current while improving redundancy of the power supply, thereby improving stability of the power supply system.

In a feasible implementation, the terminal power supply further includes a plurality of first bypass modules that are in one-to-one correspondence to the plurality of power modules. The first bypass module is electrically connected between a positive terminal and a negative terminal of a corresponding one of the power modules corresponding to the first bypass module. The first bypass module is configured to be switched into a switch-on state in response to an output anomaly of the corresponding power module, to short the positive terminal to the negative terminal of the corresponding power module. The output anomaly includes that a current value of an output current of the power module is out of a preset current range of the power module. In this way, the first bypass module may be used for fault isolation when the power module has a fault, thereby avoiding impact of the faulty power module on output stability of the terminal power supply, and improving reliability of power supply.

In a feasible implementation, the plurality of power modules are configured to adjust the current value of the output current within the preset current range during output, so that all of the power modules have same output voltages and same output powers. In this way, the output power of all power modules may be balanced and allocated to avoid heat concentration, which facilitates long-term application of the terminal power supply.

In a feasible implementation, the branching node includes at least one constant-current-to-constant-voltage conversion module. The constant-current-to-constant-voltage conversion module has a first terminal and a second terminal which are electrically connected to the trunk cable, a third terminal which is electrically connected to the load node through the branch cable, and a fourth terminal which is electrically connected to the ocean ground. The constant-current-to-constant-voltage conversion module is configured to receive the constant current output from the terminal power supply through the first terminal or the second terminal, convert the constant current into a constant-voltage current with a preset voltage, and output the constant-voltage current to the load node through the third terminal. In this way, the constant current may be processed in the branching node to be converted into the constant-voltage current to adapt to an operating voltage and rated power of the load node, thereby improving diversity of access devices for the power supply system, so that the power supply system may adapt to long-distance and multi-node power supply scenarios.

In a feasible implementation, the branching node further includes a first isolation module and at least one second bypass module. The first isolation module is disposed between the constant-current-to-constant-voltage conversion module and the trunk cable, and is configured to switch off a connection between the constant-current-to-constant-voltage conversion module and the trunk cable in response to a fault in the constant-current-to-constant-voltage conversion module or in the load node. The fault includes short circuits, open circuits, and abnormal grounding that occur in the constant-current-to-constant-voltage conversion module and the corresponding load node. The second bypass module is disposed on the trunk cable, with one terminal connected to the first terminal of the constant-current-to-constant-voltage conversion module through the first isolation module and the other terminal connected to the second terminal of the constant-current-to-constant-voltage conversion module through the first isolation module. The second bypass module is configured to switch on the trunk cable electrically connected to the first terminal and the second terminal of the constant-current-to-constant-voltage conversion module, in response to the fault in the constant-current-to-constant-voltage conversion module or in the load node. In this way, the faulty branching node or load node may be isolated, so as to avoid impact of the fault generated on the trunk cable and improve stability of power supply.

In a feasible implementation, the constant-current-to-constant-voltage conversion module includes an input circuit, a conversion circuit, and an output circuit. The input circuit is electrically connected to the first terminal and the second terminal, and is configured to receive and filter the constant current transmitted from the trunk cable through the first terminal or the second terminal. The conversion circuit is electrically connected to the input circuit and the output circuit, respectively, and is configured to convert, in response to the constant current filtered by the input circuit, the constant current into the constant-voltage current. The output circuit is electrically connected to the third terminal, and is configured to filter the constant-voltage current generated by the conversion circuit and output the same through the third terminal. In this way, the constant current may be converted into the constant-voltage current to meet requirements of the load nodes, so that the power supply system may supply power to a plurality of load nodes with different requirements.

In a feasible implementation, the conversion circuit includes a switch circuit, a main power transformer, and a rectifier circuit. The switch circuit is electrically connected to the input circuit and the main power transformer, respectively, the rectifier circuit is electrically connected to the main power transformer and the output circuit, respectively, and the main power transformer is disposed on an electrical insulation and isolation zone. In this way, the input current may be processed, and meanwhile crosstalk is reduced by the electrical insulation and isolation zone, thereby ensuring electrical safety during a constant-current-to-constant-voltage conversion process.

In a feasible implementation, a topology structure of the switch circuit includes one of a full-bridge topology and a half-bridge topology. The switch circuit includes a switch transistor, which is one of an insulated gate bipolar transistor and a metal-oxide semiconductor field-effect transistor. In this way, the constant-current-to-constant-voltage conversion process may be controlled to output the required constant-voltage current, and power of the output current may be controlled through structural settings, so as to better meet operating requirements of the corresponding load node.

In a feasible implementation, the constant-current-to-constant-voltage conversion module further includes a feedback circuit and a control circuit. The control circuit is disposed between the input circuit and the conversion circuit, and the feedback circuit is electrically connected to an output end of the conversion circuit and the control circuit, respectively. The feedback circuit is configured to generate and transmit a feedback signal to the control circuit in response to an output voltage of the conversion circuit. The control circuit is configured to generate and transmit a control signal to the conversion circuit in response to the feedback signal. In this way, the output constant-voltage current may be used to provide feedback and control to the conversion module, so that the constant-current-to-constant-voltage conversion module is kept in an output state, thereby improving stability of power supply for the load node.

In a feasible implementation, the branching node is electrically connected to the load node through the branch cable. When there are two or more load nodes corresponding to the branching node, the load nodes may be disposed in series and/or parallel on the branch cable corresponding to the branching node. An input voltage of each of the load nodes is less than or equal to a voltage of the constant-voltage current output from the branching node. Input power of each of the load nodes is less than or equal to power of the constant-voltage current output from the branching node. In this way, a plurality of load nodes may be accessed to a branch for power supply meanwhile, so that the power supply system may be accessed by different load nodes, thereby increasing application scenarios of the power supply system.

In a feasible implementation, the load node includes at least one load device and a second isolation module. The load device is electrically connected to the branch cable, and the second isolation module is disposed on the branch cable that is electrically connected to the load device. The second isolation module is configured to switch off a connection between the load device and the branch cable in response to a fault in the load device, so as to stop operation of the load device in fault. The fault includes short circuits, open circuits, and abnormal grounding that occur in the load device. In this way, power supply control may be performed on load devices in the load node. When faults occur to some of the load devices in the load node, normal operation of other load devices in the load node may be maintained by means of separate isolation, thereby improving reliability of power supply of the power supply system.

In a feasible implementation, when the load node is a movable load node, the branching node includes a first constant-current-to-constant-voltage conversion module, and the load node includes a second constant-current-to-constant-voltage conversion module. The first constant-current-to-constant-voltage conversion module and the second constant-current-to-constant-voltage conversion module are electromagnetically couplable to each other to connect the branching node to the load node. The second constant-current-to-constant-voltage conversion module is electrically connected to the load device in the load node. The first constant-current-to-constant-voltage conversion module is configured to convert the constant current received by the branching node into a corresponding magnetic field. The second constant-current-to-constant-voltage conversion module is configured to couple with the magnetic field generated by the first constant-current-to-constant-voltage conversion module, and generate a corresponding constant-voltage current based on the magnetic field to supply power the load device. In this way, power may be supplied to the movable load node, thereby increasing application scenarios of the power supply system and improving reliability of the power supply system.

In a feasible implementation, when there are two or more terminal power supplies, the terminal power supplies include at least one first terminal power supply and at least one second terminal power supply. Both the first terminal power supply and the second terminal power supply are electrically connected to the trunk cable. An output polarity of the first terminal power supply is opposite to that of the second terminal power supply. In this way, a plurality of terminal power supplies may be utilized for power supply, so as to increase redundancy of power supply and reduce output load of a single terminal power supply, thereby reducing faults caused by long-term and high-load operation, and improving operational stability of the terminal power supply.

The embodiments of the present application provide a long-distance power supply system, which supplies power through the terminal power supply with constant current output. The branching node is connected to the load node, and may convert the constant current, so as to supply power to the corresponding load node through the constant-voltage current. Meanwhile, the branching node is connected to the ocean ground, so that the power supply system may perform current return through grounding, so as to reduce the cables disposed between the branching node and the load node, thereby reducing the costs of long-distance power supply while reducing the damages to the stability of power supply that are caused by cable damages.

### BRIEF DESCRIPTION OF THE DRAWINGS

To describe the technical solutions of the present application to be more clear, the accompanying drawings for the embodiments are briefly described below. Obviously, persons of ordinary skills in the art may also derive, without an effective effort, other accompanying drawings from these accompanying drawings.

FIG. 1 is a schematic diagram of a structure of a power supply system of a submarine observation network;

FIG. 2 is a schematic diagram of a structure of a long-distance underwater power supply system according to an embodiment of the present application;

FIG. 3 is a schematic diagram of a structure of another long-distance underwater power supply system according to an embodiment of the present application;

FIG. 4 is a schematic diagram of a structure of a terminal power supply according to an embodiment of the present application;

FIG. 5 is a schematic diagram of a current value and a voltage value or power of an output current according to an embodiment of the present application;

FIG. 6 is a schematic diagram of a structure of a branching node according to an embodiment of the present application;

FIG. 7 is a schematic diagram of a structure of another branching node according to an embodiment of the present application;

FIG. 8 is a schematic diagram of a structure of a constant-current-to-constant-voltage conversion module according to an embodiment of the present application;

FIG. 9 is a schematic diagram of a structure of another constant-current-to-constant-voltage conversion module according to an embodiment of the present application;

FIG. 10 is a schematic diagram of a structure of a feedback circuit and a control circuit according to an embodiment of the present application;

FIG. 11 is a schematic diagram of a structure of a load node according to an embodiment of the present application;

FIG. 12 is a schematic diagram of a connection mode between a branching node and a load node according to an embodiment of the present application; and

FIG. 13 is a schematic diagram of another connection mode between a branching node and a load node according to an embodiment of the present application.

### DETAILED DESCRIPTION OF THE EMBODIMENTS

The technical solutions in the embodiments of the present application are clearly described below in conjunction with the accompanying drawings for the embodiments of the present application.

In description of the present application, unless otherwise stated, “/” means “or”. For example, A/B may represent A or B. “and/or” in this specification refers to only an association relationship that describes associated objects, indicating presence of three relationships. For example, A and/or B may indicate presence of three cases: An alone, both A and B, and B alone. In addition, “at least one” means one or more; and “a plurality of” means two or more. Terms “first” and “second” do not limit quantities or an execution order, and do not limit definite differences.

It should also be understood that, in the present application, unless otherwise specified and limited, the term “connect” may refer to an electrical connection, a communication connection, or a physical connection. Meanwhile, “connect” may be a direct connection, or an indirect connection through an intermediate medium.

It should also be understood that, in the present application, words such as “exemplary” or “for example” are used to indicate examples, instances, or explanations. Any embodiments or design schemes described as “exemplary” or “for example” in the present application should not be interpreted as being more preferred or advantageous than other embodiments or design schemes. Specifically, use of the words such as “exemplary” or “for example” is intended to present relevant concepts in a concrete way.

A submarine observation network is an Earth scientific observation platform, where a series of underwater monitoring stations are established on a seabed by interconnection of fiber optic cables, base stations, underwater monitoring devices, and control instruments, so as to form a submarine network system that may perform long-term real-time exploration, data transmission, sample collection and analysis, and in-situ experiments for a submarine area. This system may achieve all-weather, long-term, dynamic, and real-time in-situ observation for marine layers, submarine layers, and submarine rock layers, to provide important data support for a plurality of fields such as scientific research, environmental protection, and disaster warning.

As devices in the submarine observation network typically need to continuously receive power to keep operating, a power supply system corresponding to the submarine observation network is an important component system for the submarine observation network. Power supply schemes for the submarine observation network at present are mainly divided into two types: a constant-voltage mode and a constant-current mode, where by the constant-voltage mode of power supply, typically a high-voltage direct current is generated from a power supply device at the terminal station, and a submarine device needs to convert the high-voltage direct current into an operating voltage required by the instrument through a high-voltage power supply; and by the constant-current mode of power supply, a direct current is generated from the power supply device at the terminal station, and the submarine device needs to convert the current into a required voltage.

FIG. 1 is a schematic diagram of a structure of a power supply system of a submarine observation network.

As shown in FIG. 1, the power supply system that supplies power to the submarine observation network may include a shore-base power supply device 110, a trunk cable 120, a branching unit 130, and a branch cable 140. The shore-base power supply device 110 is disposed on shore to provide a power supply current. The trunk cable 120 is electrically connected to the shore-base power supply device 110, and the branching unit 130 is disposed on the trunk cable 120. The branch cable 140 is electrically connected to the branching unit 130, and may obtain the power supply current from the trunk cable 120 through the branching unit 130, so as to supply power to observation devices 150 in the submarine observation network.

As an example, the shore-base power supply device 110 may be a constant-voltage power supply device or a constant-current power supply device. The observation devices 150 may be provided with a transformer for receiving a constant-voltage current or a constant current transmitted from the branch cable 140, and converting a voltage of the power supply current into an operating voltage required by the observation devices 150 to supply power to the observation devices 150.

As the observation devices 150 are disposed at different positions in the submarine observation network, a distribution distance thereof may be far from the shore-base power supply device 110. Due to transmission performance and distances of the trunk cable 120 and the branch cable 140, there is a significant loss of current during transmission. Therefore, in the constant-voltage mode of power supply, a high-voltage direct current is usually used for power supply, and for example, the voltage may be 15 kV. Correspondingly, although a high-voltage power supply may reduce losses during transmission, a design thereof is complex. and faults generated in the power supply may affect all devices served by the power supply. Moreover, a high voltage may inevitably bring in noise and serious interference to the observation devices 150, so that additional filtering measures need to be designed for the observation devices 150, which affects reliability of the power supply system.

However, if the shore-base power supply device 110 is a constant-current power supply device, not only will there be cable losses during transmission, but also a total voltage for the observation devices 150 in the entire power supply system to draw power may not exceed a maximum output voltage of the shore-base power supply device 110, and thus the power supply device is only suitable for supplying power to small and medium power devices, and is not suitable for long-distance and multi-node submarine observation networks.

To resolve the foregoing issue, the present application provides a long-distance underwater power supply system, in which a constant-current power supply is used to provide a constant current to a trunk cable, and the constant current on the trunk cable is converted into a constant-voltage current through a branching node to supply power to a load. Meanwhile, current return is implemented through grounding of the branching node and the load, thereby decreasing cables disposed in the power supply system and improving reliability of long-distance power supply.

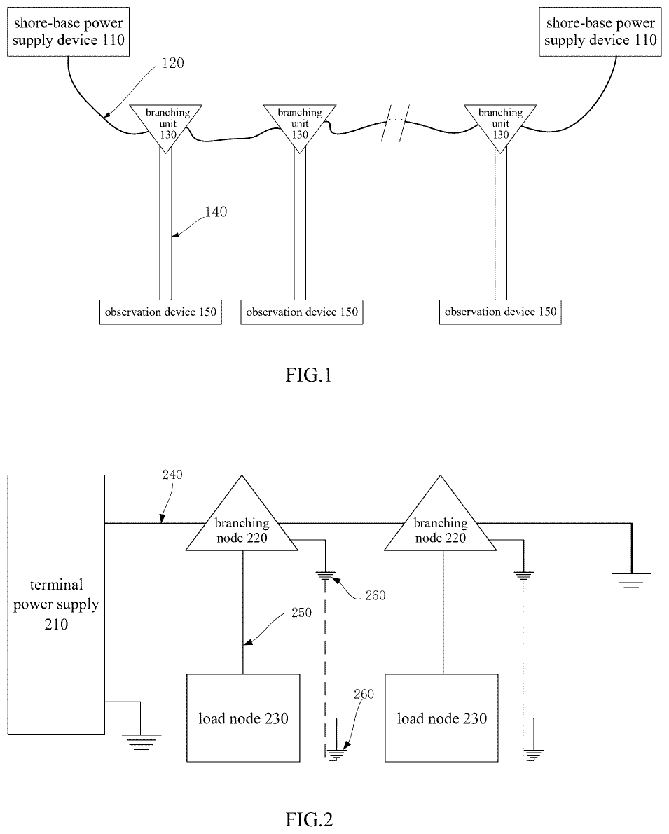

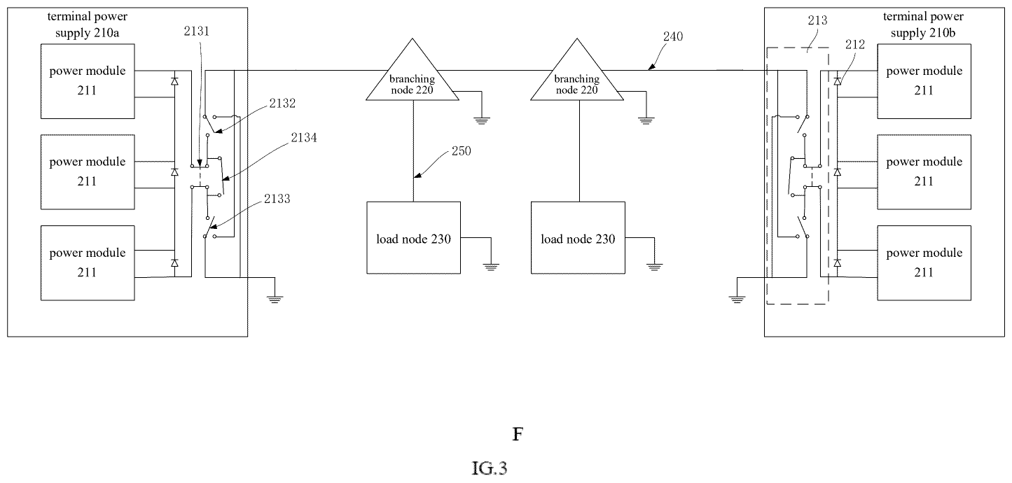

FIG. 2 is a schematic diagram of a structure of a long-distance underwater power supply system according to an embodiment of the present application.

As shown in FIG. 2, the long-distance underwater power supply system according to this embodiment of the present application includes at least one terminal power supply 210 and a plurality of branching nodes 220 to supply power to a plurality of load nodes 230 in a submarine observation system, respectively.

As an example, one terminal power supply 210 is disposed in the system. As shown in FIG. 2, the terminal power supply 210 is sequentially electrically connected to the plurality of branching nodes 220 through a trunk cable 240, and the plurality of branching nodes 220 are connected to corresponding load nodes 230, respectively. In this way, the terminal power supply 210 may output a current to the trunk cable 240 to supply power to the load nodes 230 through the branching nodes 220.

In this embodiment of the present application, an output current of the terminal power supply 210 is a constant current, that is, the terminal power supply 210 is a constant-current power supply. The branching node 220 may convert the constant current transmitted from the trunk cable 240 into a constant-voltage current, and output the converted constant-voltage current to the load node 230, so as to supply power to the load node 230.

Further, taking the electrical connection between the branching node 220 and the load node 230 as an example, a cable disposed between the branching node 220 and the load node 230 may be a branch cable 250 of the power supply system, and one branching node 220 corresponds to at least one load node 230. Therefore, the branching node 220 may be connected to one or more load nodes 230 through the branch cable 250.

It should be understood that various modes may be adopted for electrically connecting one branching node 220 to one load node 230. For example, a dual-cable mode is adopted for the electrical connection, or a bipolar cable is used for the electrical connection. A specific mode of the branch cable 250 for the electrical connection between the branching node 220 and the load node 230 is not limited by this embodiment of the present application.

In some embodiments of the present application, each branching node 220 is connected to an ocean ground 260. Current return of the power supply system may be achieved through the branching node 220 by grounding of the branching node 220. In this way, one branching node 220 may be electrically connected to one load node 230 through one branch cable 250, and the branch cable 250 may be a conventional monopole submarine power supply cable, so that use of cables is reduced and issues of underwater cable entanglement during long-distance power supply are avoided. Meanwhile, compared to bipolar cables, monopole cables do not require conductive layers and insulation layers, thereby reducing costs of long-distance power supply of the power supply system.

It should be understood that each branching node 220 and the corresponding load node 230 are disposed to be common-grounded, so that the branching node 220 and the corresponding load node 230 may form a loop, thereby decreasing power supply cables, lowering costs of long-distance power supply, and reducing occurrence of unstable power supply caused by cable damages.

FIG. 3 is a schematic diagram of a structure of another long-distance underwater power supply system according to an embodiment of the present application.

There may be a plurality of terminal power supplies 210 disposed in the power supply system. When there are two or more terminal power supplies 210, the terminal power supplies 210 include at least one first terminal power supply and at least one second terminal power supply. Both the first terminal power supply and the second terminal power supply are electrically connected to a trunk cable 240. An output polarity of the first terminal power supply is opposite to that of the second terminal power supply.

For example, there may be two terminal power supplies 210 disposed in the power supply system. As shown in FIG. 3, the power supply system may include a terminal power supply 210a and a terminal power supply 210b. The terminal power supply 210a may serve as the first terminal power supply and the terminal power supply 210b may serve as the second terminal power supply. The terminal power supply 210a and the terminal power supply 210b are respectively disposed at two terminals of the trunk cable 240, and an output polarity of the terminal power supply 210a is opposite to that of the terminal power supply 210b.

When there are two terminal power supplies 210 disposed in the power supply system, if the two terminal power supplies 210 both operate normally, each terminal power supply 210 outputs 50% of a system voltage and 50% of total power. If one of terminal power supplies 210 has a serious fault, power supply of the one of the terminal power supplies 210 with the serious fault may be switched off, so that the other of terminal power supplies 210 provides 100% of the system voltage and 100% of the total power.

It should be understood that the foregoing structure of disposing a plurality of terminal power supplies 210 is only a feasible implementation in the present application, and the connection mode between the plurality of terminal power supplies 210 and the trunk cable 240 is not limited by this embodiment of the present application.

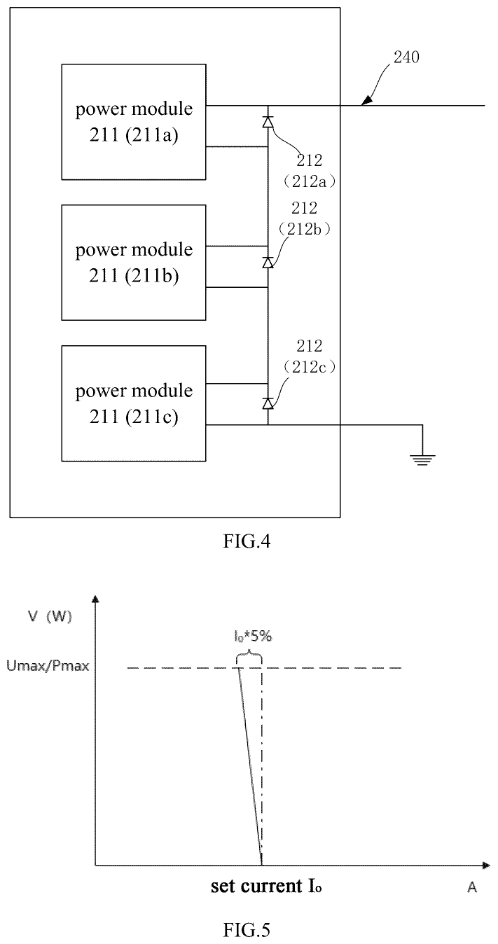

FIG. 4 is a schematic diagram of a structure of a terminal power supply according to an embodiment of the present application.

As shown in FIG. 4, the terminal power supply 210 in the power supply system may include a plurality of power modules 211 that are connected in series. A positive terminal of one of the power modules 211 serves as an output end of the terminal power supply 210, and is electrically connected to the trunk cable 240 to provide a constant current to the trunk cable 240.

It should be understood that in this embodiment of the present application, the power modules 211 each output a constant current, so that the terminal power supply 210 may output a corresponding constant current through the output end. Further, the plurality of power modules 211 connected in series may output a constant current with a higher voltage, thereby increasing output power of the terminal power supply 210.

In this embodiment of the present application, a current value of the output current of the power module 211 may be adjusted within a preset current range for output, so that all of the power modules 211 have the same output voltages and the same output powers, improving output uniformity of the terminal power supply 210, and meanwhile helping adjusting of the output voltages and balancing of the output powers by fine-tuning the output currents among the plurality of power modules 211, thereby avoiding heat concentration and facilitating long-term stable and reliable operation of the terminal power supply 210.

FIG. 5 is a schematic diagram of a current value and a voltage value or power of an output current according to an embodiment of the present application.

As shown in FIG. 5, the preset current range in this embodiment of the present application may be 95%˜100% of a set current of the output current of the terminal power supply 210. If the set current of the output current of the terminal power supply 210 is I₀, the power module 211 may adjust an output current value thereof within a range of 95% ×I₀˜I₀.

It should be understood that the set current of the terminal power supply 210 is a preset value of the output current of the terminal power supply 210 while the terminal power supply 210 maintains a voltage of the output current to a highest output voltage Umax or maintains power to highest output power Pmax in an output state. For example, if the set current I₀ may be 2 A, an adjustment range of the output current value of the power module 211 is 1.9 A˜2 A.

In some embodiments of the present application, the adjustment range of the output current value of the power module 211 may also be other numerical values, for example, may be 97%˜100% of the set current I₀. It should be noted that, the set current I₀ and the adjustment range of the output current value of the power module 211 are both exemplary numerical values and ranges given in the present application. The specific numerical value of the set current I₀ and the specific adjustment range of the output current value of the power module 211 may also be other numerical values, which is not limited by the embodiments of the present application.

Taking the terminal power supply 210 shown in FIG. 4 as an example, there may be three power modules 211 disposed in the terminal power supply 210, that is, a power module 211a, a power module 211b, and a power module 211c. The power module 211a, the power module 211b, and the power module 211c are connected in series. An output negative electrode of the power module 211a is electrically connected to an output positive electrode of the power module 211b, an output negative electrode of the power module 211b is electrically connected to an output positive electrode of the power module 211c, and an output negative electrode of the power module 211c is grounded. An output positive electrode of the power module 211a is the output end of the electrode power supply 210. In this way, by connection of the power modules 211 in series, output stability of the terminal power supply 210 may be improved.

Further, the terminal power supply 210 further includes a plurality of first bypass modules 212 that are in one-to-one correspondence to the plurality of power modules 211. The first bypass module 212 is electrically connected between the positive terminal (that is, the output positive electrode in the foregoing embodiment) and a negative terminal (that is, the output negative electrode in the foregoing embodiment) of the power module 211 corresponding to the first bypass module 212.

That the terminal power supply 210 includes three power modules 211 is used as an example. The terminal power supply 210 may include three first bypass modules 212, that is, a first bypass module 212a, a first bypass module 212b, and a first bypass module 212c. Two terminals of the first bypass module 212a are electrically connected to the output positive electrode and the output negative electrode of the power module 211a, respectively. Two terminals of the first bypass module 212b are electrically connected to the output positive electrode and the output negative electrode of the power module 211b, respectively. Two terminals of the first bypass module 212c are electrically connected to the output positive electrode and the output negative electrode of the power module 211c, respectively.

For example, the first bypass module 212 may be a switch structure with a trigger structure, such as a switch, a diode, or a transistor. When the power modules 211 all operate normally, each of the first bypass modules 212 is in a switch-off state, so that the output current may flow through each of the power modules 211 sequentially while the power modules 211 are connected in series,.

When an output anomaly occurs to the power module 211 corresponding to one of the first bypass modules 212, the first bypass module 212 is switched to a switch-on state to short the output positive electrode to the output negative electrode of the power module 211 corresponding to the first bypass module 212, thus preventing output currents of other power modules 211 from flowing through the power module 211 with an output anomaly, so as to isolate the power module 211 with the output anomaly, thereby improving overall output stability of the terminal power supply 210.

It should be understood that the output anomaly of the power module 211 includes that the current value of the output current of the power module 211 is out of the preset current range of the power module 211. For example, the range of the output current value of the power module 211 is 95%×I₀˜I₀. When the first bypass module 212 detects that the output current value of the power module 211 is not within this range, the output positive electrode and the output negative electrode of the power module 211 may be shorted to short the power module 211.

Further, a trigger current or a trigger voltage may be set for the first bypass module 212. When the power module 211 outputs normally, the first bypass module 212 would not be triggered, thus maintaining in a switch-off state, where the power module 211 may output a current normally. When there is an output anomaly in the power module 211, in response to the output anomaly, the output positive electrode and the output negative electrode of the power module 211 are switched on through the first bypass module 212 at external of the power module 211, so as to short the power module 211 to avoid an output anomaly of the terminal power supply 210.

In some embodiments, the first bypass module 212 may also control the power module 211 by monitoring output such as the output current of the corresponding power module 211 in a real-time manner. When it is monitored by the first bypass module 212 that the output current value of the power module 211 to which the first bypass module 212 is connected is not within the preset current range, the output positive electrode and the output negative electrode of the power module 211 may be switched on at external of the power module 211, so as to isolate the power module, thereby preventing an unstable output current from affecting output of the terminal power supply 210.

For example, there is an output anomaly in the power module 211b. When it is monitored by the first bypass module 212b that the power module 211b has an output anomaly or the first bypass module 212b is triggered by an output current of the power module 211b, a branch where the first bypass module 212b is located may be switched on. In this case, the output positive electrode and the output negative electrode of the power module 211b are communicated at external of the power module 211b, so that output currents of the power module 211a and the power module 211c would not flow through the power module 211b. Thus, the power module 211b is isolated, thereby preventing the power module 211b with the output anomaly from affecting stable output of the terminal power supply 210.

It should be noted that the structures of the first bypass module 212 in the foregoing embodiments are only several examples of the first bypass module 212 in the present application, and the first bypass module 212 may also have other structures that may implement the foregoing functions. The structure of the first bypass module 212 is not limited by the embodiments of the present application.

In the embodiments of the present application, the power module 211 and the first bypass module 212 are provided, so that the power supply of the terminal power supply 210 may be made more stable, thereby lowering a probability of issues occurring during the operation of the terminal power supply 210.

In some embodiments of the present application, when the power supply system includes a plurality of terminal power supplies 210, output polarities of the terminal power supplies 210 may be switched based on structural settings. As shown in FIG. 3, it is taken as an example that two terminal power supplies 210 serve as a power source of a power supply system, where the two terminal power supplies 210, the trunk cable 240, and the branching node 220 connected to the trunk cable 240 form a power-supply trunk circuit. When a plurality of power modules 211 in the terminal power supply 210 are connected in series for output, a polarity switching module 213 is further disposed at a position where the power modules 211 is connected to the trunk cable 240, so that the two terminal power supplies 210 that form the power-supply trunk circuit may be switched to different polarities, thereby meeting requirements of power supply.

For example, the polarity switching module 213 may include a polarity selection switch 2131, a first isolation switch 2132, a second isolation switch 2133, and a bypass switch 2134. When both terminal power supplies 210 operate normally, the first isolation switch 2132 and the second isolation switch 2133 are in a switch-on state, while the bypass switch 2134 is in a switch-off state. Moreover, one of the terminal power supplies 210 is switched to a positive polarity for output by the polarity selection switch 2131, and the other terminal power supply 210 is switched to a negative polarity for output by the polarity selection switch, so that currents output from the plurality of power modules 211 may smoothly enter the trunk cable 240. It should be noted that, when operating normally, each of the two terminal power supplies 210 may output 50% of the system voltage and 50% of the total power.

When one of the terminal power supplies 210 has a serious fault, the corresponding first isolation switch 2132 and second isolation switch 2133 are switched off, and the corresponding bypass switch 2134 is switched on, so as to isolate the faulty terminal power supply 210, thereby avoiding impact on power supply of the power supply system. In this case, the other terminal power supply 210 in the power supply system may provide 100% of the system voltage and 100% of the total power that are output by the power supply system.

It should be noted that serious faults in the terminal power supply 210 include short circuits, open circuits, abnormal grounding or the like occurring to each of the power modules 211 in the terminal power supply 210, or short circuits, open circuits, abnormal grounding, or the like occurring to the overall of the terminal power supply 210. Faults in some of the power modules 211 in the terminal power supply 210 would not trigger actions of the first isolation switch 2132, the second isolation switch 2133, and the bypass switch 2134. When faults occur to some of the power modules 211, the first bypass module 212 in the foregoing embodiments may operate, description of which is not repeated here in the present application.

In the embodiments of the present application, by providing a plurality of terminal power supplies 210, output power of a single terminal power supply 210 may be reduced, redundancy of the power supply system may be improved, and issues of unstable power supply due to the fault of the single terminal power supply 210 may be reduced, thereby improving stability of long-distance power supply.

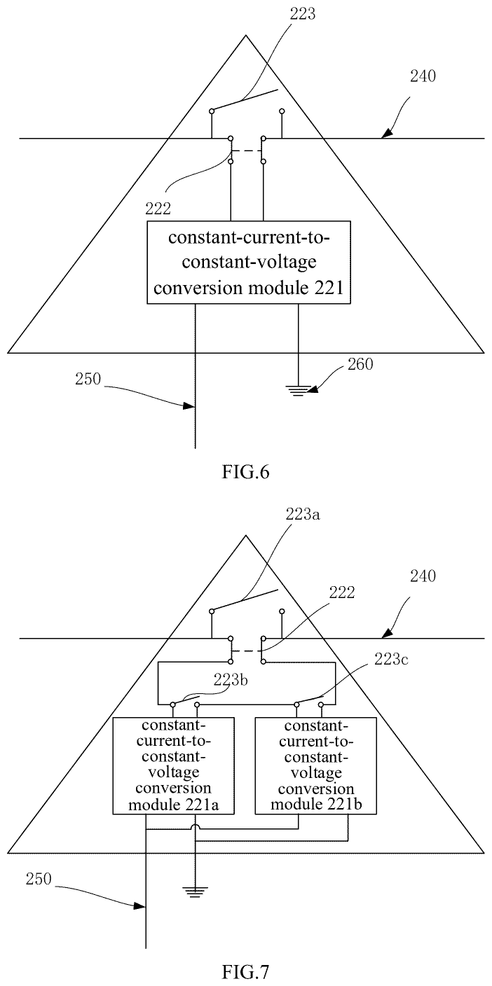

FIG. 6 is a schematic diagram of a structure of a branching node according to an embodiment of the present application.

In the embodiments of the present application, the terminal power supply 210 outputs a constant current to the trunk cable 240 to supply power to the load node 230 connected to the branching node 220. To improve power supply efficiency, the branching node 220 may convert the constant current transmitted from the trunk cable 240 into a constant-voltage current, so as to supply power to the load node 230.

In some embodiments of the present application, as shown in FIG. 6, the branching node 220 includes at least one constant-current-to-constant-voltage conversion module 221 having a first terminal and a second terminal which are electrically connected to the trunk cable 240, a third terminal which is electrically connected to the load node 230 through the branch cable 250, and a fourth terminal which is electrically connected to the ocean ground 260.

In this way, the constant-current-to-constant-voltage conversion module 221 may receive the constant current output from the terminal power supply 210 through the first terminal or the second terminal, convert the constant current into a constant-voltage current with a preset voltage, and output the constant-voltage current to the load node 230 through the third terminal, where the preset voltage is same as an operating voltage of the load node 230.

It should be understood that there are differences in operating voltages and powers of the load nodes 230 connected to different branching nodes 220. Therefore, a voltage value of the constant-voltage current output from the constant-current-to-constant-voltage conversion module 221 in each branching node 220 may be adjusted according to the different load nodes 230 connected thereto, thereby providing appropriate input currents for each load node 230 for power supply.

Further, the branching node 220 further includes a first isolation module 222 and at least one second bypass module 223. A number of second bypass modules 223 in one branching node 220 is related to that of constant-current-to-constant-voltage conversion modules 221 in the branching node 220. In some embodiments of the present application, if the number of the constant-current-to-constant-voltage conversion modules 221 in the branching node 220 is n, when n is 1, the number of the second bypass modules 223 in the branching node 220 is also n; and when n is greater than 1, the number of the second bypass modules 223 in the branching node 220 is n+1.

In the embodiments of the present application, the first isolation module 222 is configured to switch on or off connection between the constant-current-to-constant-voltage conversion module 221 and the trunk cable 240, and the second bypass module 223 is configured to switch on the trunk cable 240 electrically connected to the constant-current-to-constant-voltage conversion module 221 after the communication between the constant-current-to-constant-voltage conversion module 221 and the trunk cable 240 is switched off, so as to avoid impact of the fault in the branching node 220 on the power supply of other stations on the trunk cable 240.

Specifically, the first isolation module 222 may be disposed between the constant-current-to-constant-voltage conversion module 221 and the trunk cable 240, and may be connected to the first terminal and the second terminal of the constant-current-to-constant-voltage conversion module 221. Therefore, when there is a fault in this branch, the fault may be isolated timely, thereby avoiding impact on power supply of the power supply system to other devices in the submarine observation network. For example, the first isolation module 222 may be a switch module disposed between the constant-current-to-constant-voltage conversion module 221 and the trunk cable 240. The switch module may control switch on or off of the connection between the constant-current-to-constant-voltage conversion module 221 and the trunk cable 240 in response to operating states of the constant-current-to-constant-voltage conversion module 221 and the load node 230.

In some embodiments of the present application, the first isolation module 222 may receive operating state information of the constant-current-to-constant-voltage conversion module 221 and the load node 230, so as to perform fault isolation timely when the constant-current-to-constant-voltage conversion module 221 or the load node 230 has a fault. For example, the fault in the constant-current-to-constant-voltage conversion module 221 or the load node 230 includes short circuits, open circuits, and abnormal grounding occurring to the constant-current-to-constant-voltage conversion module 221 and the corresponding load node 230.

In this way, the first isolation module 222 may switch off the connection between the constant-current-to-constant-voltage conversion module 221 and the trunk cable 240 after receiving fault information of the constant-current-to-constant-voltage conversion module 221 or the load node 230, so as to isolate the faulty node, thereby improving stability of power supply.

In the embodiments of the present application, if the number of the second bypass module 223 is 1, the second bypass module 223 may be disposed on the trunk cable 240, with one terminal connected to the first terminal of the constant-current-to-constant-voltage conversion module 221 through the first isolation module 222 and the other terminal connected to the second terminal of the constant-current-to-constant-voltage conversion module 221 through the first isolation module 222. In this way, after the constant-current-to-constant-voltage conversion module 221 is isolated by the first isolation module 222, the trunk cable 240 may be switched on, thereby avoiding issues of transmission interruption of the trunk cable 240 after the isolation.

In some embodiments, the second bypass module 223 may also receive the operating state information of the constant-current-to-constant-voltage conversion module 221 and the load node 230, so that the trunk cable 240 electrically connected to the first terminal and the second terminal of the constant-current-to-constant-voltage conversion module 221 is switched on timely when the constant-current-to-constant-voltage conversion module 221 or the load node 230 has a fault, thereby improving fault processing efficiency of the branching node 220.

FIG. 7 is a schematic diagram of a structure of another branching node according to an embodiment of the present application.

In some embodiments, the branching node 220 may include a plurality of constant-current-to-constant-voltage conversion modules 221 and a plurality of second bypass modules 223. Therefore, by means of providing redundant devices, when faults occurs to one constant-current-to-constant-voltage conversion module 221 in the branching node 220, power may still be supplied to the load node 230, thereby improving stability of power supply of the power supply system.

As shown in FIG. 7, the branch node 220 is provided with a constant-current-to-constant-voltage conversion module 221a and a constant-current-to-constant-voltage conversion module 221b. The constant-current-to-constant-voltage conversion module 221b is a redundant backup device for the constant-current-to-constant-voltage conversion module 221a. In some embodiments, the constant-current-to-constant-voltage conversion module 221a may also be a redundant backup device for the constant-current-to-constant-voltage conversion module 221b, which is not limited by the present application.

The constant-current-to-constant-voltage conversion module 221a has a second terminal electrically connected to a first terminal of the constant-current-to-constant-voltage conversion module 221b, and a first terminal electrically connected to the trunk cable 240 through the first isolation module 222, and a second terminal of the constant-current-to-constant-voltage conversion module 221b is electrically connected to the trunk cable 240 through the first isolation module 222. In this way, the constant-current-to-constant-voltage conversion module 221a and the constant-current-to-constant-voltage conversion module 221b have same inputs, and may be isolated for fault by the first isolation module 222.

In the embodiments, when the branching node 220 is provided with two constant-current-to-constant-voltage conversion modules 221, the branching node 220 is provided with three second bypass modules 223, that is, a second bypass module 223a, a second bypass module 223b, and a second bypass module 223c. The second bypass module 223a is disposed on the trunk cable 240, with one terminal connected to the first terminal of the constant-current-to-constant-voltage conversion module 221a and the other terminal connected to the second terminal of the constant-current-to-constant-voltage conversion module 221b.

Moreover, the second bypass module 223b is disposed between the first terminal and the second terminal of the constant-current-to-constant-voltage conversion module 221a, and the second bypass module 223c is disposed between the first terminal and the second terminal of the constant-current-to-constant-voltage conversion module 221b. When the branching node 220 operates normally, the first isolation module 222 is in a switch-on state, while the second bypass module 223a, the second bypass module 223b, and the second bypass module 223c are all in a switch-off state.

For example, when the constant-current-to-constant-voltage conversion module 221a has a fault and the fault is detected by the second bypass module 223b, the second bypass module 223b may switch on the first terminal and the second terminal of the constant-current-to-constant-voltage conversion module 221a, so as to isolate the constant-current-to-constant-voltage conversion module 221a, so that the faulty constant-current-to-constant-voltage conversion module 221a would not affect conversion of the constant-current-to-constant-voltage conversion module 221b for the constant current.

Similarly, when the constant-current-to-constant-voltage conversion module 221b has a fault, the second bypass module 223c may make a response to isolate the constant-current-to-constant-voltage conversion module 221b, to avoid interference from the fault on the conversion of the constant current.

Further, if the load node 230 connected to the branching node 220 has a fault or both of the constant-current-to-constant-voltage conversion modules 221a and 221b have faults, the first isolation module 222 in the branching node 220 may switch off, in response to the fault, the connection between the constant-current-to-constant-voltage conversion modules 221a and 221b and the trunk cable 240, and the second bypass module 223a may switch on, in response to the fault, the trunk cable 240 in the branching node 220, thereby preventing the fault from affecting other branching nodes 220 on the trunk cable 240.

FIG. 8 is a schematic diagram of a structure of a constant-current-to-constant-voltage conversion module according to an embodiment of the present application.

As shown in FIG. 8, the constant-current-to-constant-voltage conversion module 221 may include an input circuit 2211, a conversion circuit 2212, and an output circuit 2213. The input circuit 2211 is a circuit configured to receive the constant current transmitted from the trunk cable 240, the conversion circuit 2212 is a circuit configured to convert the constant current, and the output circuit 2213 is a circuit configured to process and output the converted constant-voltage current.

Specifically, the input circuit 2211 is electrically connected to the first terminal and the second terminal of the constant-current-to-constant-voltage conversion module 221, and may receive and filter the constant current transmitted from the trunk cable 240 through the first terminal and the second terminal of the constant-current-to-constant-voltage conversion module 221. An output end of the input circuit 2211 is electrically connected to an input end of the conversion circuit 2212, and an output end of the conversion circuit 2212 is electrically connected to an input end of the output circuit 2213. The input end of the conversion circuit 2212 receives the constant current filtered by the input circuit 2211, converts the filtered constant current into a constant-voltage current, and outputs the constant-voltage current to the output circuit 2213.

Meanwhile, after receiving the constant-voltage current, the output circuit 2213 may also filter the constant-voltage current to process the same, thereby improving stability of power supply. Moreover, the output circuit 2213 is electrically connected to the third terminal of the constant-current-to-constant-voltage conversion module 221, to transmit the filtered constant-voltage current to the corresponding load node 230 through the third terminal of the constant-current-to-constant-voltage conversion module 221. The output circuit 2213 may also be electrically connected to the fourth terminal of the constant-current-to-constant-voltage conversion module 221 to be grounded.

In some embodiments of the present application, as shown in FIG. 8, the conversion circuit 2212 may include a switch circuit 2212a, a main power transformer 2212b, and a rectifier circuit 2212c. The switch circuit 2212a may serve as an input end of the conversion circuit 2212, and is electrically connected to the input circuit 2211 and the main power transformer 2212b, so as to receive and transfer the constant current to the main power transformer 2212b for conversion. The rectifier circuit 2212c is electrically connected to the main power transformer 2212b and the output circuit 2213, so as to rectify and transmit the constant-voltage current converted by the main power transformer 2212b to the output circuit 2213.

It should be understood that the main power transformer 2212b includes a primary side and a secondary side, where the primary side is an electrical energy input end of the transformer, wherein in the embodiments of the present application, the primary side of the main power transformer 2212b is electrically connected to the switch circuit 2212a; and the secondary side is an electrical energy output end of the transformer, wherein in the embodiments of the present application, the secondary side of the main power transformer 2212b is electrically connected to the rectifier circuit 2212c.

Further, the primary side may input electrical energy from the power source into the transformer, and convert the electrical energy into magnetic energy through magnetic induction, while the secondary side outputs the electrical energy converted by the transformer to the load, thereby achieving effective utilization and distribution of the electrical energy.

According to the structure of the transformer, it may be learned that the primary side is not in direct contact with the secondary sides, but the electric energy is transmitted through magnetic induction. Therefore, the main power transformer 2212b is disposed on an electrical insulation and isolation zone, where the electrical insulation and isolation zone has an insulation voltage withstand standard which is designed in accordance to a maximum operating voltage of the power supply system. In the embodiments of the present application, the maximum operating voltage may be set according to the higher value between a value of a highest operating voltage of the terminal power supply 210 and a value of a highest voltage of the constant-voltage current converted by the constant-current-to-constant-voltage conversion module 221. In this way, faults caused by voltage breakdown on a high-voltage side of the transformer may be avoided, so as to ensure electrical safety during normal operation of the constant-current-to-constant-voltage conversion module 221, and avoid mutual signal crosstalk between the primary side and the secondary side, thereby improving operational stability of the constant-current-to-constant-voltage conversion module 221.

In the embodiments of the present application, operating voltages and operating powers of the load nodes 230 connected to the branching nodes 220 are different. Therefore, the structures of the constant-current-to-constant-voltage conversion modules 221 for conversion are also different, so that different constant-voltage currents may be output by using a same constant current.

As shown in FIG. 8, the switch circuit 2212a includes a plurality of switch transistors, so that the constant-current-to-constant-voltage conversion module 221 is controlled by the switch circuit 2212a consisting of the plurality of switch transistors. For example, by a control mode of PWM (pulse width modulation), the switch transistor may adjust an output voltage of the conversion circuit 2212 by adjusting a duty cycle. In the embodiments of the present application, the duty cycle refers to a ratio of duration of a high-level pulse to entire cycle duration within one pulse cycle. For example, a duty cycle of 50% indicates that the duration of the high-level pulse is half of the entire cycle duration within one pulse cycle.

Taking the conversion circuit 2212 corresponding to the constant-current-to-constant-voltage conversion module 221 of a higher power as an example, the switch circuit 2212a thereof may include four switch transistors with a topology structure of a full-bridge topology. It should be noted that the constant-current-to-constant-voltage conversion module 221 of the higher power refers to a constant-current-to-constant-voltage conversion module 221 with rated power not less than 1 kW. The full-bridge topology is a bridge structure consisting of four identical switch transistors, where the four switch transistors are connected in diagonal pairs, every two switch transistors forming a group, and the groups are connected in series to a top terminal and a bottom terminal of the primary side of the main power transformer 2212b, respectively, to form the switch circuit 2212a.

In some embodiments, the topology structure of the switch circuit 2212a may also be a phase-shift full-bridge or series resonant topology. A control mode of the phase-shift full-bridge topology is to adjust the output voltage by adjusting phase of the upper and lower transistors of the bridge arms, where upper and lower switch transistors of different bridge arms have same states and have a duty cycle of 50%. A control mode of the series resonant topology is to adjust the output voltage by adjusting switch frequency, where the upper and lower switch transistors of a same bridge arm have states complementary to each other, and each occupies about 50% of the duty cycle. The specific topology structure of the switch circuit 2212a is not limited by the present application.

Further, in the embodiments of the present application, a rectifier in the rectifier circuit 2212c may be a diode or a MOSFET (Metal-Oxide Semiconductor Field-Effect Transistor), and the topology structure of the rectifier circuit 2212c may also be a full-bridge topology structure.

It should be noted that, in the switch circuit 2212a of the full-bridge topology structure, the switch transistor may be an IGBT (Insulated-Gate Bipolar Transistor). The switch transistor in the embodiments of the present application may also be of other structures that may implement the foregoing functions, and specific types of the switch transistors are not limited by the present application.

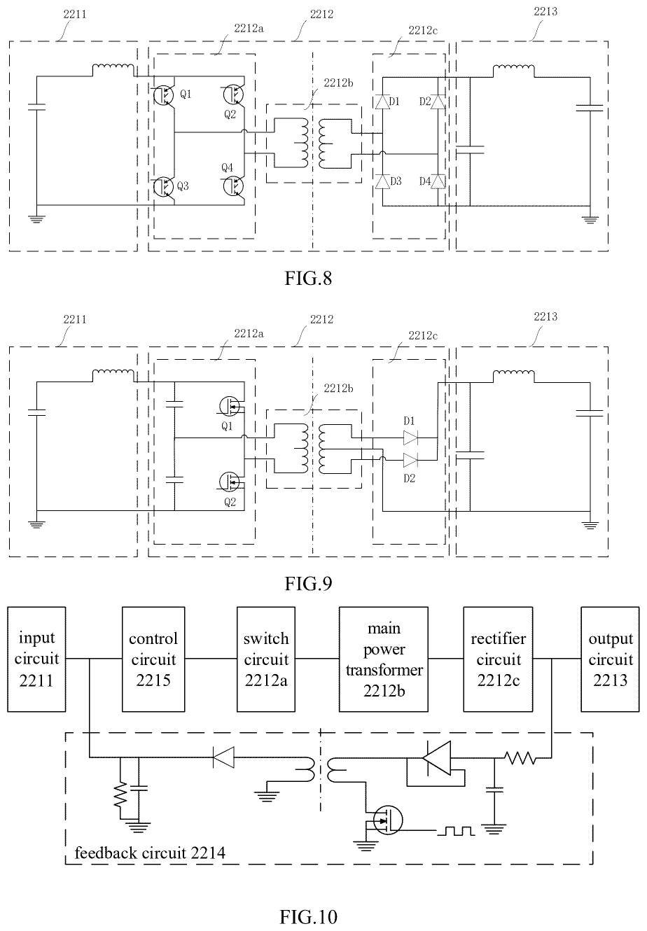

FIG. 9 is a schematic diagram of a structure of another constant-current-to-constant-voltage conversion module according to an embodiment of the present application.

Because there are a lot of observation devices in the submarine observation network and different monitoring devices have different rated powers, there is a situation where the load node 230 connected to the branching node 220 has lower rated power and is not suitable for the constant-current-to-constant-voltage conversion module 221. In some embodiments of the present application, as shown in FIG. 9, if the rated power of the load node 230 connected to the branching node 220 is relatively small, the number of switch transistors in the switch circuit 2212a in the branching node 220 may be two, and the topology structure of the switch circuit 2212a may be a half-bridge topology structure.

Specifically, the half-bridge topology consists of two switch transistors (Q1 and Q2 in FIG. 9) and a capacitor. The two switch transistors operate alternately, equivalent to that both of the switch power supplies output power. For example, the switch transistor is a MOSFET, where S electrodes (sources) of Q1 and Q2 are connected to different potential points, respectively, for example, the S electrode of Q1 connected to a transformer, and the S electrode of Q2 is grounded, so that switch on and switch off are performed alternatively.

It should be understood that the control mode of the switch circuit 2212a of the half-bridge topology structure is same as that of the switch circuit 2212a of the full-bridge topology structure. PWM is used for control, and the output voltage is adjusted by adjusting the duty cycle.

In the embodiments of the present application, the rectifier in the rectifier circuit 2212c may be a diode or an MOSFET, and the rectifier circuit 2212c may be a full-wave rectifier circuit. In other words, it is set that one terminal of one of two rectifiers is connected to a top terminal of the secondary side of the main power transformer 2212b and one terminal of the other of the two rectifiers is connected to a bottom terminal of the secondary side of the main power transformer 2212b, and the other terminals of the two rectifiers are electrically connected to the output circuit 2213, so as to rectify the constant-voltage current output from the main power transformer 2212b.

FIG. 10 is a schematic diagram of a structure of a feedback circuit and a control circuit according to an embodiment of the present application.

In the embodiments of the present application, as shown in FIG. 10, the constant-current-to-constant-voltage conversion module 221 also includes a feedback circuit 2214 and a control circuit 2215. The control circuit 2215 is disposed between the input circuit 2211 and the conversion circuit 2212, and is configured to receive a control signal to control the conversion circuit 2212. Taking the structure of the conversion circuit 2212 in the foregoing embodiment as an example, the control circuit 2215 may control output of the conversion circuit 2212 by changing a duty cycle of a signal input to the conversion circuit 2212.

Further, the feedback circuit 2214 is electrically connected to the output end of the conversion circuit 2212 and the control circuit 2215, so as to receive the constant-voltage current output from the conversion circuit 2212, and generate a corresponding feedback signal based on the output of the conversion circuit 2212 to be transmitted to the control circuit 2215, to feed back the output of the conversion circuit 2212. This helps the control circuit 2215 to drive the conversion circuit 2212 based on the feedback signal, so that after receiving the feedback signal, the control circuit 2215 may generate and transmit a control signal to the switch circuit 2212a in the conversion circuit 2212 in response to the feedback signal.

It should be understood that, the feedback circuit 2214 needs to process the signal output from the conversion circuit 2212 to generate the corresponding feedback signal. For example, in order to implement the foregoing function of generating the feedback signal, the feedback circuit 2214 is provided with an output voltage signal processing circuit, a pulse modulation circuit, a transformer circuit, and a signal rectification and filtering circuit. The output voltage signal processing circuit is electrically connected to the output end of the conversion circuit 2212, and the pulse modulation circuit and the output voltage signal processing circuit are electrically connected to a primary side of the transformer circuit, respectively. A secondary side of the transformer circuit is electrically connected to the signal rectification and filtering circuit, which is further electrically connected to the control circuit 2215 to transmit the feedback signal thereto.

The output voltage signal processing circuit includes mainly operational amplifiers, and proportionally converts the output voltage into a feedback signal. The pulse modulation circuit modulates, an output voltage signal of the conversion circuit 2212 by receiving a pulse signal with a duty cycle of 50%, into an alternate-current signal with a duty cycle of 50% to be transmitted to the secondary side of the transformer circuit through the transformer circuit. Further, the rectification and filtering circuit restores the modulated signal with a duty cycle of 50% into a linear output voltage feedback signal, which is provided to the corresponding control circuit 2215. After receiving the output voltage feedback signal, the control circuit 2215 outputs a driving signal to the switch circuit 2212a according to different topology modes.

It should be noted that the primary side of the transformer circuit is connected to the secondary side of the main power transformer 2212b through the rectifier circuit 2212c, and the secondary side of the transformer circuit is connected to the primary side of the main power transformer 2212b through the control circuit 2215 and the switch circuit 2212a. Therefore, for the main power transformer 2212b, a signal transmission direction in the feedback circuit 2214 is actually transmission of the feedback signal from the secondary side to the primary side of the main power transformer 2212b.

Further, for the transformer circuit, in addition to transformation of the voltage, electrical isolation between the primary side and the secondary side is achieved in the feedback circuit 2214. It should be noted that, in the embodiments of the present invention, the main power transformer 2212b, the transformer circuit, and other transformers involving electrical isolation between the primary side and the secondary side are all located on the electrical insulation and isolation zone. The insulation voltage withstand standard of the electrical insulation and isolation zone is designed according to the highest operating voltage of the system, thereby ensuring electrical safety during normal operation of the constant-current-to-constant-voltage conversion module 221 and avoiding mutual signal crosstalk between the primary side and the secondary side.

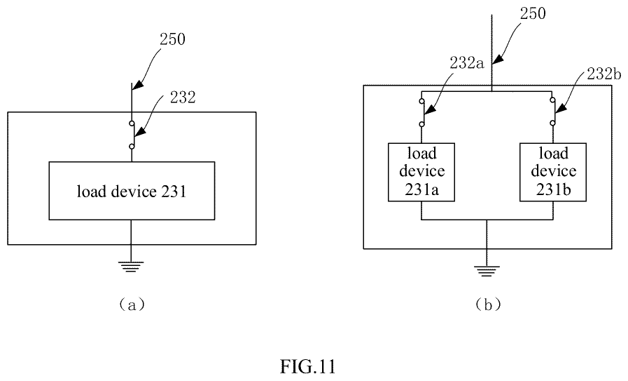

FIG. 11 is a schematic diagram of a structure of a load node according to an embodiment of the present application.

After generating the constant-voltage current corresponding to the constant current by the constant-current-to-constant-voltage conversion module 221, the branching node 220 may transmit the converted constant-voltage current to the load node 230 through the connection to the corresponding load node 230, so as to supply power to the load node 230.

As shown in FIG. 11, the load node 230 includes at least one load device 231 and a second isolation module 232. In a scenario where the branching node 220 is connected to the load node 230 through the branch cable 250, the load device 231 is electrically connected to the branch cable 250, and the second isolation module 232 is disposed on the branch cable that is electrically connected to the load device 231.

When a fault occurs to the load device 231, the second isolation module 232 may switch off, in a response to the fault, the connection between the load device 231 in faulty and the branch cable 250, so as to isolate the load device 231 in faulty, thereby avoiding further damages to the load device 231 that are caused by the power supply of the system, while not affecting power supply of the power supply system to other load nodes 230 and load devices 231. In the embodiments of the present application, the fault in the load device 231 includes short circuits, open circuits, abnormal grounding, and other faults.

As shown in FIG. 11(a), there may be one load device 231 disposed in a load node 230. Therefore, there is also one second isolation module 232 disposed at a position where the load device 231 is connected to the branch cable 250. Moreover, the second isolation module 232 may monitor an operating state of the load device 231 to obtain information indicating whether a fault occurs to the load device 231. When it is detected by the second isolation module 232 that a fault occurs to the load device 231, the second isolation module 232 may switch off the connection between the load device 231 and the branch cable 250, so as to isolate the load device 231 in faulty.

In some embodiments, one load node 230 may include a plurality of load devices 231, which may be disposed in parallel in the load node 230. Correspondingly, a number of the second isolation modules 232 which is the same as that of the load devices 231 need to be disposed in the load node 230, so as to isolate the faulty devices respectively when faults occur to different load devices 231.

As shown in FIG. 11 (b), two load devices 231 may be disposed in a load node 230, that is, a load device 231a and a load device 231b, and the load device 231a and the load device 231b are disposed in parallel. A second isolation module 232a is disposed at a position where the load device 231a is connected to the branch cable 250, and a second isolation module 232b is disposed at a position where the load device 231b is connected to the branch cable 250. The second isolation module 232a may monitor an operating state of the load device 231a, and the second isolation module 232b may monitor an operating state of the load device 231b. When it is detected by the second isolation module 232a or the second isolation module 232b that a fault occurs to the corresponding load device 231, the connection between the corresponding load device 231 and the branch cable 250 may be switched off, so as to disconnect the load device 231 in faulty from the power supply system, thereby avoiding instable power supply caused by the fault of the load device 231.

In some embodiments of the present application, the first isolation module 222 and the second bypass module 223 in the branching node 220 may obtain an operating state of the load node 230 based on the state of the second isolation module 232, and then adjust a communication state between the branching node 220 and the trunk cable 240. For example, if it is detected that each second isolation module 232 connected to the branching node 220 is in a switch-off state, it indicates that faults occur to all of the load devices 231 connected to that branching node 220. In this case, it is needed to switch off power supply to these devices, so as to improve overall power supply stability of the power supply system.

It should be understood that the first isolation module 222 and the second bypass module 223 may obtain the operating state of the load node 230 based on the state of the second isolation module 232, or may obtain the operating state of the load node by directly detecting the load device 231, which is not limited by the present application.

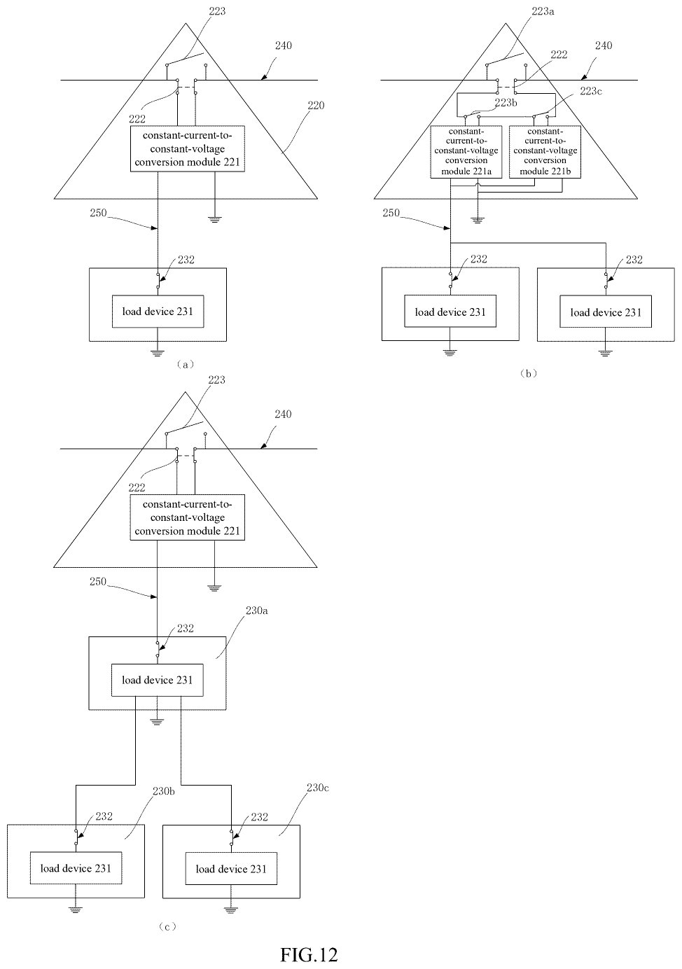

FIG. 12 is a schematic diagram of a connection mode between a branching node and a load node according to an embodiment of the present application.

In some embodiments of the present application, the branching node 220 may be electrically connected to the load node 230 through the branch cable 250, and the load node 230 may obtain electrical energy to be supplied thereto through the branch cable 250. As shown in FIG. 12(a), the branching node 220 is electrically connected to one load node 230 through the branch cable 250. The constant-voltage current converted by the branching node 220 is transmitted to the load node 230 through the branch cable 250, so as to provide power to the load node 230.

In some other embodiments of the present application, there are also scenarios where there are two or more load nodes 230 corresponding to the branching node 220. As shown in FIG. 12(b), when there are two load nodes 230 connected to the branching node 220, the load nodes 230 may be disposed in parallel on the branch cable 250 corresponding to the branching node 220, so as to receive the constant-voltage current output from the branching node 220. In this case, an input voltage of each of the load nodes 230 is less than or equal to the voltage of the constant-voltage current output from the branching node 220, and input power of each of the load nodes 230 is less than or equal to the power of the constant-voltage current output from the branching node 220.

In some other embodiments, as shown in FIG. 12(c), one branching node 220 may be connected to more than two load nodes 230. For example, a load node 230a is electrically connected to the branching node 220 through the branch cable 250, while load nodes 230b and 230c are electrically connected to the load node 230a, so that the load nodes 230b and 230c may receive the constant-voltage current output from the branching node 220 through the branch cable 250 and the load node 230a. In the embodiments of the present application, when a same branching node 220 corresponds to a plurality of load nodes 230, the plurality of load nodes 230 are also disposed to be common-grounded, thereby forming a power supply loop.

It should be understood that the plurality of load nodes 230 may also be connected in series on the branch cable 250 connected to a branching node 220. A connection mode between the plurality of load nodes 230 and the branching node 220 is not limited by the present application.

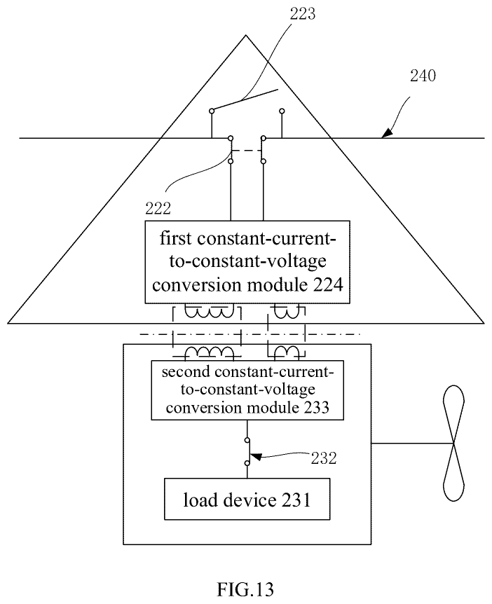

FIG. 13 is a schematic diagram of another connection mode between a branching node and a load node according to an embodiment of the present application.

Because there may be mobile observation devices in the submarine observation system, the connection between the branch cable 250 and the branching node 220 may restrict movement of the movable load node 230, so that no better observation effects may be achieved. Therefore, in some other embodiments of the present application, the load node 230 may also indirectly transmit the electrical energy to the branching node 220.

As shown in FIG. 13, when the load node 230 is a movable load node, the branching node 220 may include a first constant-current-to-constant-voltage conversion module 224, and the load node 230 may include a second constant-current-to-constant-voltage conversion module 233. The first constant-current-to-constant-voltage conversion module 224 and the second constant-current-to-constant-voltage conversion module 233 may be electromagnetically coupled to connect the branching node 220 to the load node 230.

The second constant-current-to-constant-voltage conversion module 233 is electrically connected to the load device 231 in the load node 230. The first constant-current-to-constant-voltage conversion module 224 may convert the constant-current received by the branching node 220 into a corresponding magnetic field. After being coupled with the magnetic field generated by the first constant-current-to-constant-voltage conversion module 224, the second constant-current-to-constant-voltage conversion module 233 may generate a corresponding constant-voltage current based on the magnetic field to supply power to the load device 231.

It should be understood that, the first constant-current-to-constant-voltage conversion module 224 cooperate with the second constant-current-to-constant-voltage conversion module 233 to implement the functions of the foregoing constant-current-to-constant-voltage conversion module 221. Therefore, structures of the first constant-current-to-constant-voltage conversion module 224 and the second constant-current-to-constant-voltage conversion module 233 are similar to that of the constant-current-to-constant-voltage conversion module 221 in the foregoing embodiments. Specifically, the first constant-current-to-constant-voltage conversion module 224 may be all components in the constant-current-to-constant-voltage conversion module 221 in the foregoing embodiments that are connected to the primary side of the main power transformer 2212b through cables. In other words, the first constant-current-to-constant-voltage conversion module 224 may implement the functions of the primary side of the constant-current-to-constant-voltage conversion module 221. The second constant-current-to-constant-voltage conversion module 233 may be all components in the constant-current-to-constant-voltage conversion module 221 in the foregoing embodiments that are connected to the secondary side of the main power transformer 2212b through cables. In other words, the second constant-current-to-constant-voltage conversion module 233 may implement the functions of the secondary side of the constant-current-to-constant-voltage conversion module 221. Structures and implementable functions of the first constant-current-to-constant-voltage conversion module 224 and the second constant-current-to-constant-voltage conversion module 233 are not described in the present application.

In this way, after the movable load node 230 moves to an electromagnetic coupling range of the branching node 220, the first constant-current-to-constant-voltage conversion module 224 and the second constant-current-to-constant-voltage conversion module 233 may be used to achieve wireless transmission of the electrical energy. The access modes of the load node 230 are added, so that the power supply system may supply power to movable devices in the submarine observation network.

Through the description of the foregoing implementations, a person skilled in the art may clearly understand that, for convenience and simplicity of the description, division of the foregoing functional modules is described only as examples. In practical applications, the foregoing function allocation may be implemented by different functional modules as needed. In other words, an internal structure of a device may be divided into different functional modules to implement all or some of the functions described above.

In several embodiments provided in the present application, it should be understood that the disclosed device and method may be implemented in other manners. For example, the embodiments of the devices described above are merely exemplary. For example, the division of modules or units is only a division of logical functions. In actual implementations, there may be other division manners. For example, a plurality of units or components may be combined or may be integrated into another device, or some features may be ignored or not implemented. In addition, the shown or discussed mutual coupling or direct coupling or communication connection may be indirect coupling or communication connections through some interfaces, devices, or units, and may be in electrical or other forms.

The units described as separated parts may be or may not be physically separated; and parts shown as units may be one or more physical units, that is, may be located at one place or may be distributed to a plurality of different places. Some or all of the units may be selected according to actual requirements to achieve the objectives of the solutions of the embodiments.

The foregoing content is merely specific implementations of the present application, but the protection scope of the present application is not limited thereto. Any change or replacement within the technical scope disclosed in the present application shall fall within the protection scope of the present application. Therefore, the protection scope of the present application shall be subject to the protection scope of the claims.

What is claimed is:

1. A long-distance underwater power supply system, being applied to a submarine observation system comprising a plurality of load nodes, wherein the power supply system comprises at least one terminal power supply and a plurality of branching nodes, wherein
the terminal power supply is sequentially electrically connected to the plurality of branching nodes through a trunk cable, and is configured to output a constant current to the trunk cable;
the plurality of branching nodes are respectively connected to the load nodes corresponding to the branching nodes, wherein each of the branching nodes corresponds to at least one load node, the branching node is electrically connected to the load node through a branch cable, and each of the branching nodes and each of the load nodes are respectively connected to an ocean ground, respectively, the branching node and the load node corresponding to the branching node returning currents through the ocean ground; and
the branching node is configured to convert the constant current transmitted from the trunk cable into a constant-voltage current, and output the constant-voltage current to the load node.

2. The long-distance underwater power supply system according to claim 1, wherein
the terminal power supply comprises a plurality of power modules that are connected in series, and a positive terminal of one of the power modules is electrically connected to the trunk cable.

3. The long-distance underwater power supply system according to claim 2, wherein
the terminal power supply further comprises a plurality of first bypass modules that are in one-to-one correspondence to the plurality of power modules, and the first bypass module is electrically connected between a positive terminal and a negative terminal of a corresponding one of the power modules corresponding to the first bypass module; and
the first bypass module is configured to be switched into a switch-on state in response to an output anomaly of the corresponding power module, to short the positive terminal to the negative terminal of the corresponding power module, wherein the output anomaly comprises that a current value of an output current of the power module is out of a preset current range of the power module.

4. The long-distance underwater power supply system according to claim 3, wherein
the plurality of power modules are configured to adjust the current value of the output current within the preset current range during output, so that all of the power modules have same output voltages and same output powers.

5. The long-distance underwater power supply system according to claim 1, wherein
the branching node comprises at least one constant-current-to-constant-voltage conversion module having a first terminal and a second terminal which are electrically connected to the trunk cable, a third terminal which is electrically connected to the load node through the branch cable, and a fourth terminal which is electrically connected to the ocean ground; and
the constant-current-to-constant-voltage conversion module is configured to receive the constant current output from the terminal power supply through the first terminal or the second terminal, convert the constant current into a constant-voltage current with a preset voltage, and output the constant-voltage current to the load node through the third terminal.

6. The long-distance underwater power supply system according to claim 5, wherein
the branching node further comprises a first isolation module and at least one second bypass module;
the first isolation module is disposed between the constant-current-to-constant-voltage conversion module and the trunk cable, and is configured to switch off a connection between the constant-current-to-constant-voltage conversion module and the trunk cable in response to a fault in the constant-current-to-constant-voltage conversion module or in the load node, wherein the fault comprises short circuits, open circuits, or abnormal grounding that occur in the constant-current-to-constant-voltage conversion module and the corresponding load node; and
the second bypass module is disposed on the trunk cable, with one terminal connected to the first terminal of the constant-current-to-constant-voltage conversion module through the first isolation module and an other terminal connected to the second terminal of the constant-current-to-constant-voltage conversion module through the first isolation module, and the second bypass module is configured to switch on the trunk cable electrically connected to the first terminal and the second terminal of the constant-current-to-constant-voltage conversion module, in response to the fault in the constant-current-to-constant-voltage conversion module or in the load node.

7. The long-distance underwater power supply system according to claim 5, wherein
the constant-current-to-constant-voltage conversion module comprises an input circuit, a conversion circuit, and an output circuit, wherein the input circuit is electrically connected to the first terminal and the second terminal, and is configured to receive and filter the constant current transmitted from the trunk cable through the first terminal or the second terminal;
the conversion circuit is electrically connected to the input circuit and the output circuit, respectively, and is configured to convert, in response to the constant current filtered by the input circuit, the constant current into the constant-voltage current; and
the output circuit is electrically connected to the third terminal, and is configured to filter the constant-voltage current generated by the conversion circuit and output the constant-voltage current through the third terminal.

8. The long-distance underwater power supply system according to claim 7, wherein
the conversion circuit comprises a switch circuit, a main power transformer, and a rectifier circuit, wherein the switch circuit is electrically connected to the input circuit and the main power transformer, respectively, the rectifier circuit is electrically connected to the main power transformer and the output circuit, respectively, and the main power transformer is disposed on an electrical insulation and isolation zone.

9. The long-distance underwater power supply system according to claim 8, wherein
a topology structure of the switch circuit comprises one of a full-bridge topology and a half-bridge topology; and
the switch circuit comprises a switch transistor, the switch transistor being one of an insulated gate bipolar transistor and a metal-oxide semiconductor field-effect transistor.

10. The long-distance underwater power supply system according to claim 7, wherein
the constant-current-to-constant-voltage conversion module further comprises a feedback circuit and a control circuit, wherein the control circuit is disposed between the input circuit and the conversion circuit, and the feedback circuit is electrically connected to an output end of the conversion circuit and the control circuit, respectively;
the feedback circuit is configured to generate and transmit a feedback signal to the control circuit in response to an output voltage of the conversion circuit; and
the control circuit is configured to generate and transmit a control signal to the conversion circuit in response to the feedback signal.

11. The long-distance underwater power supply system according to claim 1, wherein
when there are two or more load nodes corresponding to the branching node, the load nodes are disposed in series and/or parallel on the branch cable corresponding to the branching node, wherein an input voltage of each of the load nodes is less than or equal to a voltage of the constant-voltage current output from the branching node, and input power of each of the load nodes is less than or equal to power of the constant-voltage current output from the branching node.

12. The long-distance underwater power supply system according to claim 1, wherein
the load node comprises at least one load device and a second isolation module, wherein the load device is electrically connected to the branch cable, and the second isolation module is disposed on the branch cable that is electrically connected to the load device; and
the second isolation module is configured to switch off a connection between the load device and the branch cable in response to a fault in the load device, so as to stop operation of the load device in fault, wherein the fault comprises short circuits, open circuits, or abnormal grounding that occur in the load device.

13. The long-distance underwater power supply system according to claim 12, wherein
when the load node is a movable load node, the branching node comprises a first constant-current-to-constant-voltage conversion module, and the load node comprises a second constant-current-to-constant-voltage conversion module, wherein the first constant-current-to-constant-voltage conversion module and the second constant-current-to-constant-voltage conversion module are electromagnetically couplable to each other to connect the branching node to the load node, and the second constant-current-to-constant-voltage conversion module is electrically connected to the load device in the load node;
the first constant-current-to-constant-voltage conversion module is configured to convert the constant current received by the branching node into a corresponding magnetic field; and
the second constant-current-to-constant-voltage conversion module is configured to couple with the magnetic field generated by the first constant-current-to-constant-voltage conversion module, and generate a corresponding constant-voltage current based on the magnetic field to supply power to the load device.

14. The long-distance underwater power supply system according to claim 1, wherein
when there are two or more terminal power supplies, the terminal power supplies comprise at least one first terminal power supply and at least one second terminal power supply, wherein both the first terminal power supply and the second terminal power supply are electrically connected to the trunk cable, and an output polarity of the first terminal power supply is opposite to that of the second terminal power supply.
